(19) United States
(12) Patent Application Publication
(10) Pub. No.: US 2015/0180235 A1
(43) Pub. Date: Jun. 25, 2015

(54) Method for Controlling Multiple Appliances Powered by a Common DC Bus

(71) Applicants: Richard Landry Gray, Saratoga, CA (US); Po Ming Tsai, Taipei (TW)

(72) Inventors: Richard Landry Gray, Saratoga, CA (US); Po Ming Tsai, Taipei (TW)

(21) Appl. No.: 14/583,104

(22) Filed: Dec. 25, 2014

Related U.S. Application Data
(60) Provisional application No. 61/920,642, filed on Dec. 24, 2013.

(51) Int. Cl. H02J 1/14

(52) U.S. Cl. CPC H02J 1/14

(57) ABSTRACT

A method for controlling multiple appliances powered by a common DC bus, comprising acts providing a controller connected to the common DC bus with multiple appliances, wherein the multiple appliances are connected in parallel; the controller embedding a command by interrupting an AC input voltage for generating a modulated AC voltage, wherein the command comprises an instruction; providing a converter connected to the controller that converts the modulated AC voltage to a modulated DC voltage, wherein the modulated DC voltage has a ripple voltage; the appliances receiving the command embedded in modulated DC voltage from the common DC bus; and the appliances executing the instruction when the command is verified.

This application claims priority benefit under 35 USC 119 of provisional patent applications Ser. No. 61/920642 filed 24 Dec. 2013.

### FIELD OF THE INVENTION

Embodiments of the present disclosure relate to a control method, and especially toward a method for controlling multiple alliances powered by a common DC bus.

### BACKGROUND

Some known technologies proposed several simple communications scenarios whereby a control unit can communicate a signal to an appliance through the power line to an appliance, the appliance can interpret the control signal and then produce a certain output that is consistent with the communicated signal. Moreover, some prior art methods provide a central control unit that controls multiple addressed appliances. All of those prior art schemes work well when the power line signal is connected directly to each appliance.

For a situation when all appliances are connected to a common DC bus in parallel, and especially for an extra control signal to the individual appliances, the existing prior art solutions would be impossible to implement.

### Some Exemplary Embodiments

These and other needs are addressed by the present disclosure, wherein an approach is provided for a method for controlling multiple appliances powered by a common DC bus.

According to one aspect of an embodiment of the present disclosure, the method for controlling multiple appliances powered by a common DC bus, comprising acts providing a controller connected to the common DC bus with multiple appliances , wherein the multiple appliances are parallel connected; the controller embedding a command by interrupting an AC input voltage for generating a modulated AC voltage, wherein the command comprises an instruction; providing a converter connected to the controller that converts the modulated AC voltage to a modulated DC voltage, wherein the modulated DC voltage has a ripple voltage; the appliances receiving the command embedded in modulated DC voltage from the common DC bus; and the appliances executing the instruction when the command is verified.

### BRIEF DESCRIPTION OF THE DRAWINGS

The disclosure is illustrated by way of example, and not by way of limitation, in the figures of the accompanying drawings in which like reference numerals refer to similar elements and in which:

FIG. 1 is a diagram of multiple appliances connected in parallel to a common DC bus in accordance with an embodiment of the present invention;

FIG. 2 is a flow chart of a method for controlling multiple appliances powered by a common DC bus in accordance with an embodiment of the present disclosure;

FIG. 3 is a diagram showing the relationship of a modulated DC voltage to a pulsed signal; and

FIG. 4 is a diagram showing a command corresponding to a pulsed signal.

### DESCRIPTION OF THE PREFERRED EMBODIMENT

Embodiments of the apparatus and/or methods are disclosed. In the following description, for purposes of explanation, numerous specific details are set forth in order to provide a thorough understanding of the embodiments of the disclosure. It is apparent, however, to one skilled in the art that the present disclosure may be practiced without these specific details or with an equivalent arrangement.

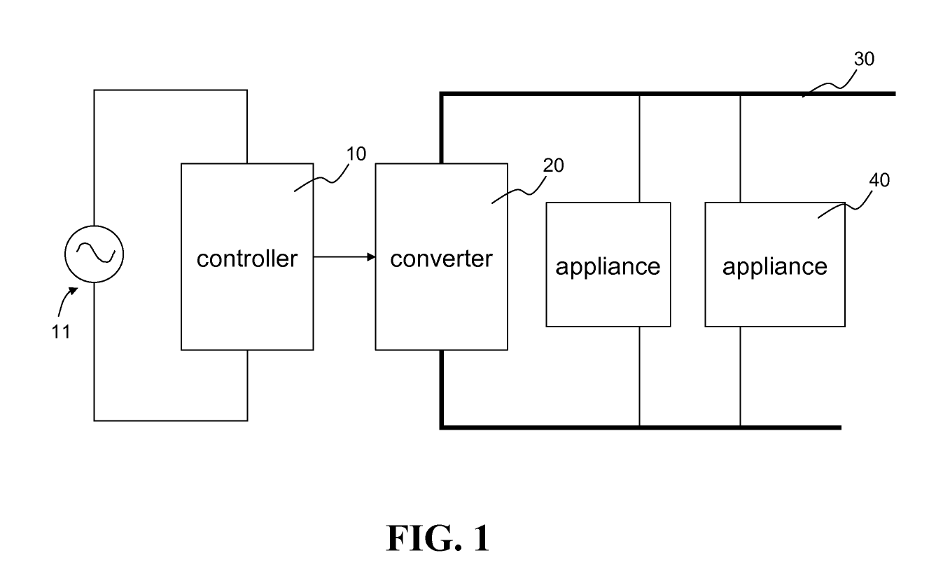

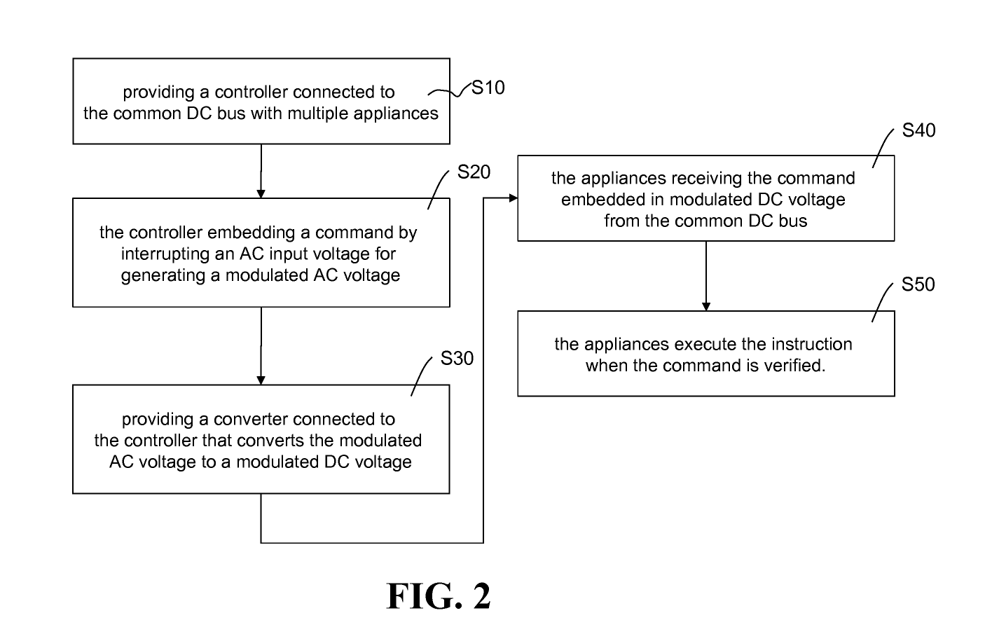

With reference to FIGS. 1 and 2, FIG. 1 is a diagram of multiple appliances connected in parallel to a common DC bus in accordance with an embodiment of the present invention; and FIG. 2 is a flow chart of a method for controlling multiple appliances powered by a common DC bus. In this invention, the method is adapted so that appliance control information can be communicated from a controller 10 (i.e., a central control unit) through an AC-DC converter 20 to a parallel connection of appliances 40 all driven by the DC bus voltage on a common DC bus 30.

The information communicated to the appliance may be the brightness of a lamp, the color of a lamp, the speed of a fan, the volume of an audio appliance or other appliances fed by an AC-DC converter.

As shown in FIG. 2, the method for controlling multiple appliances powered by a common DC bus, comprising acts of S10 providing a controller connected to the common DC bus with multiple appliances, wherein the multiple appliances are parallel connected; S20 the controller embedding a command by interrupting an AC input voltage for generating a modulated AC voltage, wherein the command comprises an instruction; S30 providing a converter connected to the controller that converts the modulated AC voltage to a modulated DC voltage, wherein the modulated DC voltage has a ripple voltage; S40 the appliances receiving the command embedded in modulated DC voltage from the common DC bus; and S50 the appliances executing the instruction when the command is verified.

The appliance looks for a sequence of the interruptions of the modulated DC voltage corresponding to a pre-determined code. The interruptions of the modulated DC voltage that do not correspond to the code will be ignored.

The appliance needs to keep its intelligence alive during the duration of a power interruption, which requires temporary supply voltage available for the intelligent portion of the appliance by means of charge stored on a capacitor, or by ensuring that during a power interruption the bus voltage never decreases below the point where the appliance's intelligence would become inactive.

As shown in FIGS. 1 to 3, the act of receiving the command embedded in modulated DC voltage from the common DC bus further comprises acts of decoding the modulated DC voltage 12 with a voltage threshold 41 within a time period; and assembling the command into a pulsed signal 42 with a high state and a low state. The act of assembling the pulsed signal comprises acts of setting falling edges when the modulated DC voltage 12 crosses under the voltage threshold 41; and setting raising edges when the modulated DC voltage 12 crosses above the voltage threshold 41.

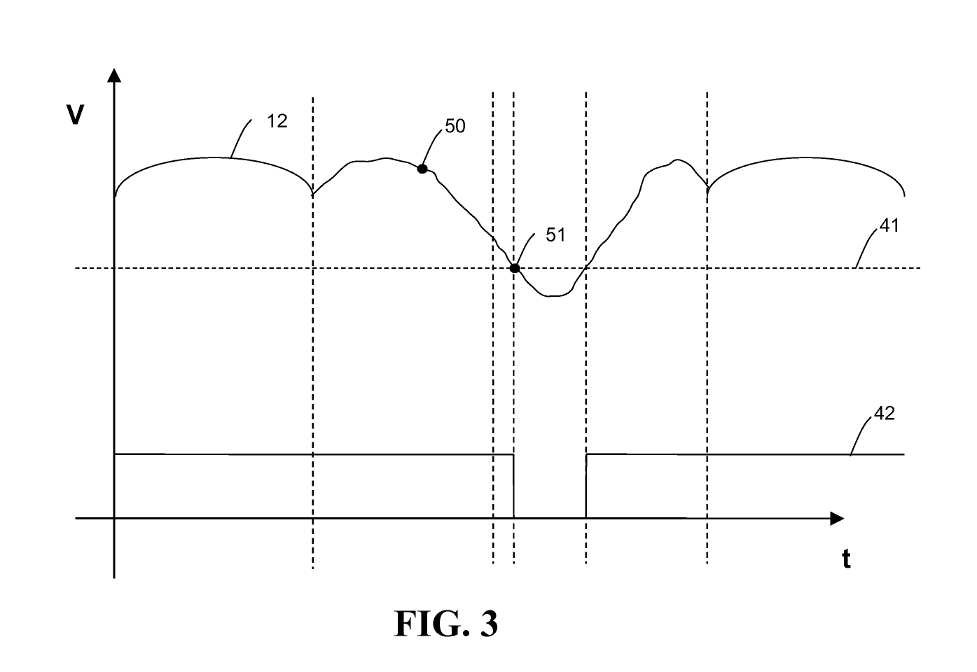

As shown in FIG. 3, the point 50 is where the controller starts to interrupt the modulated AC voltage, which causes the modulated DC voltage 12 to start to decrease. At point 51 the appliance starts to encode as the modulated DC voltage 12 has crossed the voltage threshold 41.

In order to make sure all appliances on the same DC bus use the same time reference, each appliance has an internal clock synchronized with the ripple voltage. The ripple voltage on the DC bus voltage is almost always an artifact of the frequency of the AC input voltage that fed into the controller, as such, the frequency of the bus voltage ripple is precisely controlled.

Further, for controlling multiple appliances on a common DC bus line, each appliance is given an address. The contents of the command must specify which appliance should listen to the instruction. Therefore, the command further comprises a preamble and a destination. In other words, only when the address of the corresponding appliance is verified will the instruction be executed.

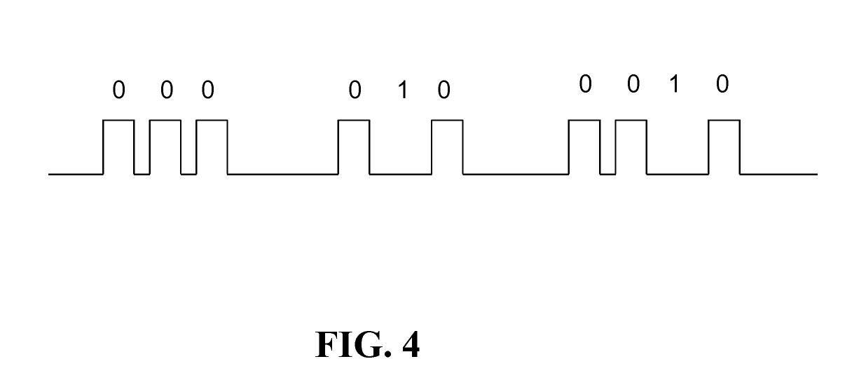

For example, when an appliance decodes the modulated DC voltage and converts it to a pulsed signal as shown in FIG. 4, it represents “000”, “010” and “0010”. In this example, “000” is the preamble of the command that indicates to all appliances that what follows will be an address. “010” is the address code that indicates the appliance with the address of 010 has been selected. “0010” is the instruction of the command. Other appliances with different destination addresses will ignore the instruction.

Accordingly, the method for controlling multiple appliances powered by a common DC bus is quite feasible, the potential number of commands is large, and there is no need to provide an extra wire for the communication between the controller and the corresponding appliances.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method for controlling multiple appliances powered by a common DC bus, comprising:
providing a controller connected to the common DC bus with multiple appliances, wherein the multiple appliances are parallel connected;
the controller embedding a command by interrupting an AC input voltage for generating a modulated AC voltage, wherein the command comprises an instruction;
providing a converter connected to the controller that converts the modulated AC voltage to a modulated DC voltage, wherein the modulated DC voltage has a ripple voltage;
the appliances receiving the command embedded in modulated DC voltage from the common DC bus; and
the appliances executing the instruction when the command is verified.

2. The method as claimed in claim 1, wherein the command further comprises a preamble and a destination address, and each appliance has a address.

3. The method as claimed in claim 2, wherein the preamble is a code that is configured for all the appliances.

4. The method as claimed in claim 2, wherein the act of executing the instruction when the command is verified, the appliances execute the instruction of the command when the destination address is matched to the address of the appliance to be controlled.

5. The method as claimed in claim 1, wherein the act of receiving the command embedded in modulated DC voltage from the common DC bus further comprises:
decoding the the modulated DC voltage with a voltage threshold within a time period; and
assembling the command into a pulsed signal with a high state and a low state, and comprising:
setting falling edges when the modulated DC voltage crosses under the voltage threshold; and
setting raising edges when the modulated DC voltage crosses above the voltage threshold.

6. The method as claimed in claim 5, wherein the act of the appliances executing the instruction when the command is verified, the appliance has a predetermined minimum width and a predetermined maximum width, and the appliance ignores the pulsed signal when the width of the high state or the low state either exceeds the predetermined maximum width or is shorter than the predetermined minimum width.

7. The method as claimed in claim 1, wherein each appliance has an internal clock synchronized with the ripple voltage.
